(19) United States
(12) Patent Application Publication
(10) Pub. No.: US 2023/0121087 A1
(43) Pub. Date: Apr. 20, 2023

(54) SOCKET ADAPTOR WITH MAGNETIC ATTRACTION

(71) Applicant: Hong Ann Tool Industries Co., Ltd., Taichung City (TW)

(72) Inventor: Cheng-Wei SU, Taichung City (TW)

(21) Appl. No.: 17/878,146

(22) Filed: Aug. 1, 2022

(30) Foreign Application Priority Data
Oct. 19, 2021 (TW) 110138748
Dec. 21, 2021 (TW) 110147971

(51) Int. Cl. B25B 23/12; B25B 23/00

(52) U.S. Cl. CPC B25B 23/12; B25B 23/0035

(57) ABSTRACT

A socket adaptor includes a shank, a body movably mounted on the shank, a detent movably arranged between the shank and the body, and a magnetic device. The magnetic device includes a limiting member and a magnetic member. The limiting member has a proximal end fixed to an end of the shank, a distal end opposite to the proximal end, and a containing hole formed at the distal end. The magnetic member is arranged in the containing hole.

### BACKGROUND

The present invention relates to a socket adaptor and, more particular, to a socket adaptor which can connect with a socket and hold a fastener in the socket by magnetic attraction.

A socket is used to connect and to turn a fastener such as a nut or bolt. In order to prevent the fastener detach from the socket or shake excessively during operation, a magnet is often arranged in the socket to magnetically attract and position the fastener, as shown in Taiwan Patent No. TWI719793, which includes a socket body and a magnetic attraction member arranged in the socket body, or as shown in Taiwan Patent No. TWM469152, which discloses a mounting hole of the socket body extended with a recess to hold a magnetic ring.

However, each of the above-mentioned sockets must have a magnetic attraction member or a magnetic ring arranged in the socket body to increase the manufacturing cost of the socket.

Thus, a need exists for a novel socket adaptor to mitigate and/or obviate the above disadvantages.

### SUMMARY

An objective of the present invention is to provide a socket adaptor including a shank, a body, a detent, and a magnetic device. The shank has a connecting end and a driven end adapted to couple with a driving tool. The body is movably mounted on the shank. The detent is movably arranged between the shank and the body and is configured to selectively engage with a socket as the body is moved relative to the shank. The magnetic device includes a limiting member and a magnetic member. The limiting member has a proximal end fixed to the connecting end of the shank, a distal end opposite to the proximal end, and a containing hole formed at the distal end. The magnetic member is arranged in the containing hole.

In an embodiment, the proximal end of the limiting member is fixed to the connecting end of the shank in a tight fit manner.

In an embodiment, the containing hole extends from the distal end to the proximal end and penetrates the proximal end. An outer diameter of the connecting end is not less than an inner diameter of the containing hole. The containing hole is fixedly sleeved on the connecting end of the shank.

In an embodiment, the containing hole extends radially inward to form a limiting portion adjacent to the distal end. An inner diameter of the limiting portion is less than the inner diameter of the containing hole. The magnetic member is limited between an end face of the connecting end of the shank and the limiting portion.

In an embodiment, two opposite sides of the magnetic member are respectively abutted against the end face of the connecting end of the shank and the limiting portion.

In an embodiment, the magnetic member is movably arranged in the containing hole.

In an embodiment, the shank forms an insertion hole at the connecting end. The limiting member is provided with an insertion portion at the proximal end. An outer diameter of the insertion portion is not less than an inner diameter of the insertion hole. The insertion portion is fixedly inserted and embedded in the insertion hole.

In an embodiment, the shank is made of a first material. The limiting member is made of a second material softer than the first material.

In an embodiment, the shank further has an annular groove formed on an outer periphery of the connecting end. The limiting member forms a mounting hole at the proximal end. The mounting hole sleeves on the connecting end of the shank. The limiting member is configured that an outer surface of the proximal end is punched and deformed by a radial force to form an engaging portion protruded from an inner surface of the mounting hole and fixedly engaged with the annular groove.

In an embodiment, the limiting member is tubular. The magnetic member is cylindrical.

The present invention will become clearer in light of the following detailed description of illustrative embodiments of this invention described in connection with the drawings.

### BRIEF DESCRIPTION OF THE DRAWINGS

FIG. 1 is a perspective view of a socket adaptor of a first embodiment according to the present invention.

FIG. 2 is a partial exploded perspective view of the socket adaptor of FIG. 1.

FIG. 3 is a partial cross sectional view of the socket adaptor of FIG. 1.

FIG. 4 is a continued view of FIG. 3 and shows the socket adaptor connected with a socket to turn a fastener.

FIG. 5 is a partial cross sectional view of a socket adaptor of a second embodiment according to the present invention.

FIG. 6 is a partial cross sectional view of a socket adaptor of a third embodiment according to the present invention.

FIGS. 7 and 8 are partial cross sectional views of a socket adaptor of fourth embodiment according to the present invention.

### DETAILED DESCRIPTION

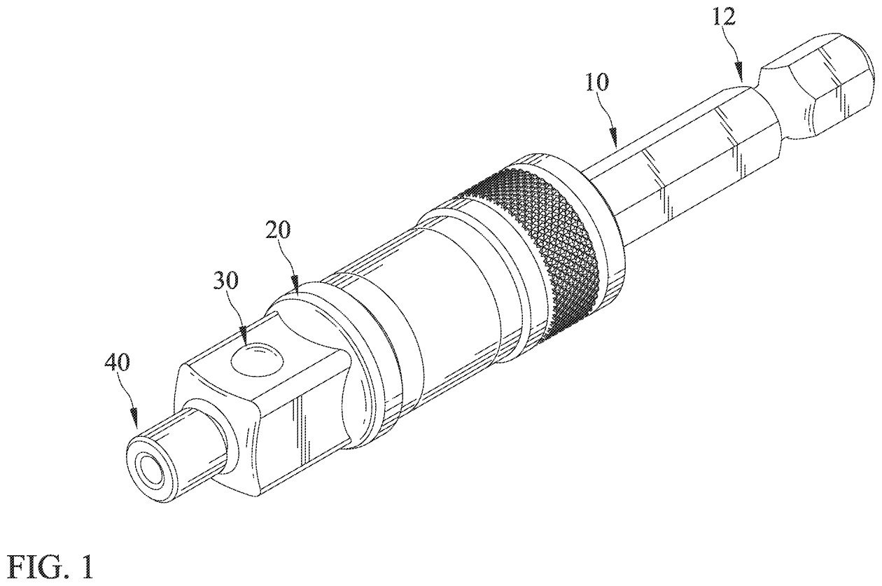

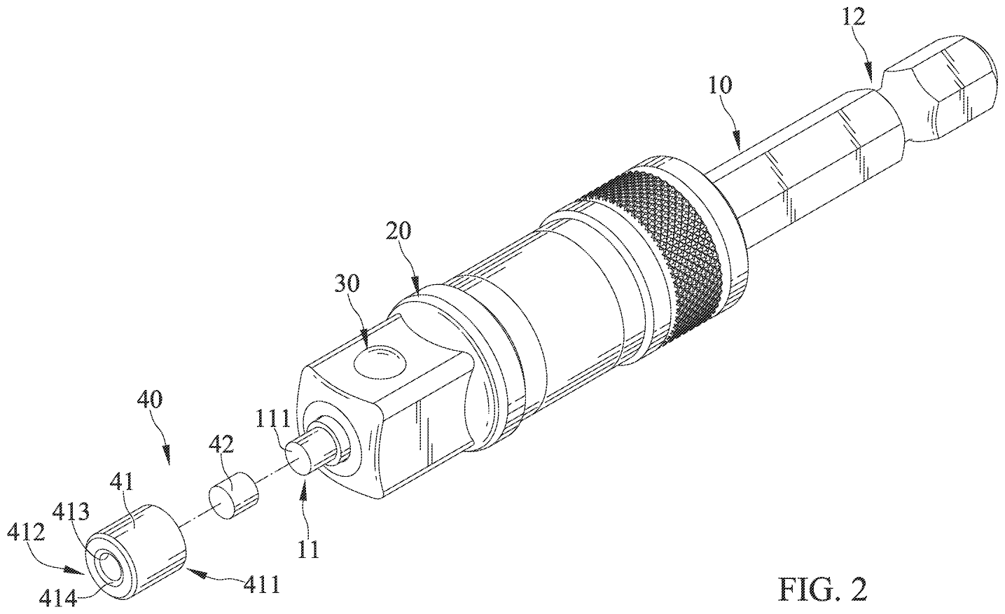

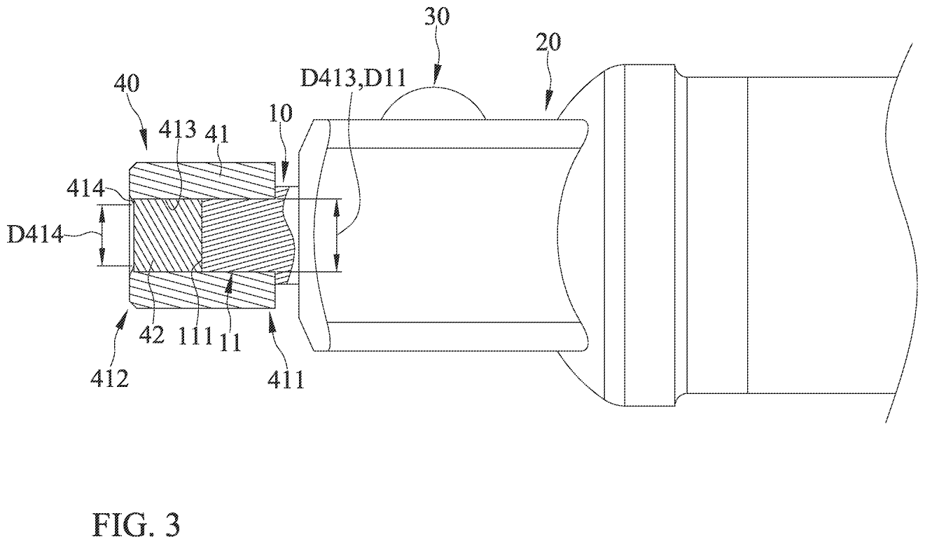

FIGS. 1-4 show a socket adaptor of a first embodiment according to the present invention. The socket adaptor includes a shank 10, a body 20, a detent 30, and a magnetic device 40.

The shank 10 has a connecting end 11 and a driven end 12 opposite to the connecting end 11. The driven end 12 is adapted to couple with a driving tool (not shown), such as a manual handle or a power tool.

The body 20 is movably mounted on the shank 10, so that the body 20 can be actuated by a user to move relative to the shank 10.

The detent 30 is movably arranged between the shank 10 and the body 20 and is configured to selectively engage with a socket 50 as the body 20 is moved relative to the shank 10. It can be understood that, the detent 30 can be a steel detent ball and can be movably limited between the shank 10 and the body 20. When the body 20 is moved relative to the shank 10 by the user, the detent 30 moves relative to the body 20 to be selectively exposed to the main body 20, so as to engage with or disengage from the socket 50.

The magnetic device 40 includes a limiting member 41 and a magnetic member 42. The limiting member 41 has a proximal end 411 fixed to the connecting end 11 of the shank 10, a distal end 412 opposite to the proximal end 411, and a containing hole 413 formed at the distal end 412. The magnetic member 42 is arranged in the containing hole 413.

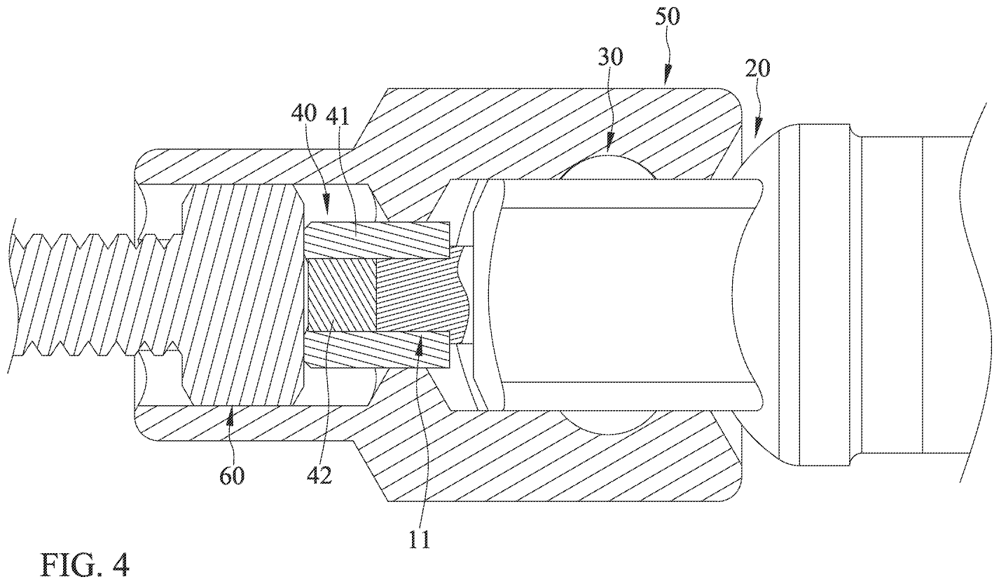

Thus, as shown in FIG. 4, when the detent 30 is engaged with the socket 50, which is connect with a fastener 60 (a bolt in this embodiment), the magnetic device 40 extends into the socket 50 and magnetically attracts the fastener 60 to prevent the fastener 60 accidentally detached from the socket 50 or excessively shaking during operation, and at the same time eliminates the inconvenience of the user having to hold the fastener 60.

In the embodiment, the limiting member 41 may be tubular, and the magnetic member 42 may be cylindrical.

In order to enable the limiting member 41 and the shank 10 to be fixedly connected to each other, in this embodiment, the proximal end 411 of the limiting member 41 is fixed to the connecting end 11 of the shank 10 in a tight fit manner.

Further, the containing hole 413 extends from the distal end 412 to the proximal end 411 and penetrates the proximal end 411. An outer diameter D11 of the connecting end 11 is not less than an inner diameter D413 of the containing hole 413, and the containing hole 413 is fixedly sleeved on the connecting end 11 of the shank 10. In other words, before the containing hole 413 is sleeved on the connecting end 11 of the shank 10, the maximum value of the inner diameter D413 of the containing hole 413 is less than the outer diameter D11 of the connecting end 11 of the shank 10, so as to be fixed in a tight fit manner on the connecting end 11 of the shank 10.

In order to stably position the magnetic member 42 in the containing hole 413 of the limiting member 41, the containing hole 413 extends radially inward to form a limiting portion 414 adjacent to the distal end 412, an inner diameter D414 of the limiting portion 414 is less than the inner diameter D413 of the containing hole 413, and the magnetic member 42 is limited between an end face 111 of the connecting end 11 of the shank 10 and the limiting portion 414 to prevent the magnetic member 42 detached from the containing hole 413. Further, in the embodiment, two opposite sides of the magnetic member 42 are respectively abutted against the end face 111 of the connecting end 11 of the shank 10 and the limiting portion 414 of the limiting member 41, so that the magnetic member 42 cannot move relative to the containing hole 413.

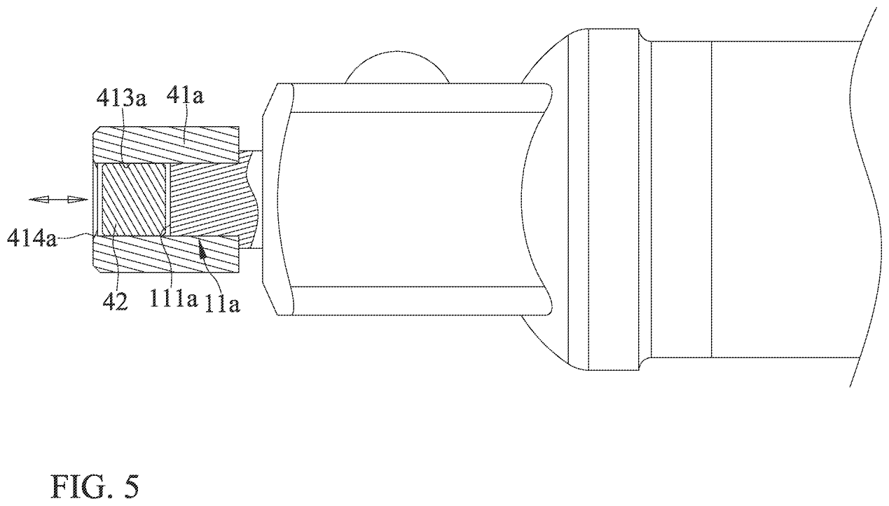

FIG. 5 shows a socket adaptor of a second embodiment according to the present invention. The second embedment is substantially the same as the first embodiment. The main differences are that the magnetic member 42 is movably arranged in the containing hole 413a, and the magnetic member 42 is limited between the end face 111a of the connecting end 11a and the limiting portion 414a so that the magnetic member 42 is prevented from being damaged by a direct collision when the socket adaptor is driven by a driving tool, so as to provide a buffering effect.

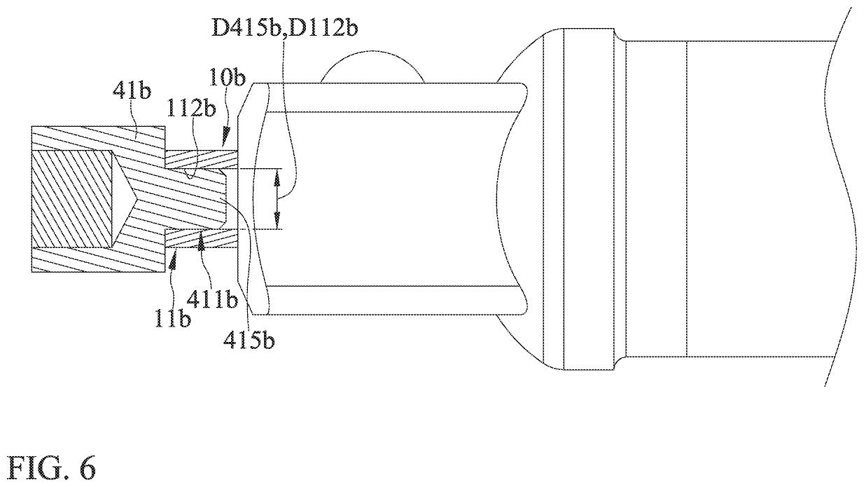

FIG. 6 shows a socket adaptor of a third embodiment according to the present invention. The third embedment is substantially the same as the first embodiment. The main differences are that the shank 10b forms an insertion hole 112b at the connecting end 11b. The limiting member 41b is provided with an insertion portion 415b at the proximal end 411b, and an outer diameter D415b of the insertion portion 415b is not less than an inner diameter D112b of the insertion hole 112b. The insertion portion 415b is fixedly inserted and embedded in the insertion hole 112b. In other words, before the insertion portion 415b is fixedly inserted into the insertion hole 112b of the shank 10b, the maximum value of the inner diameter D112b of the insertion hole 112b is less than the outer diameter D415b of the insertion portion 415b, so that the insertion hole 112b can be tightly fitted with the insertion portion 415b.

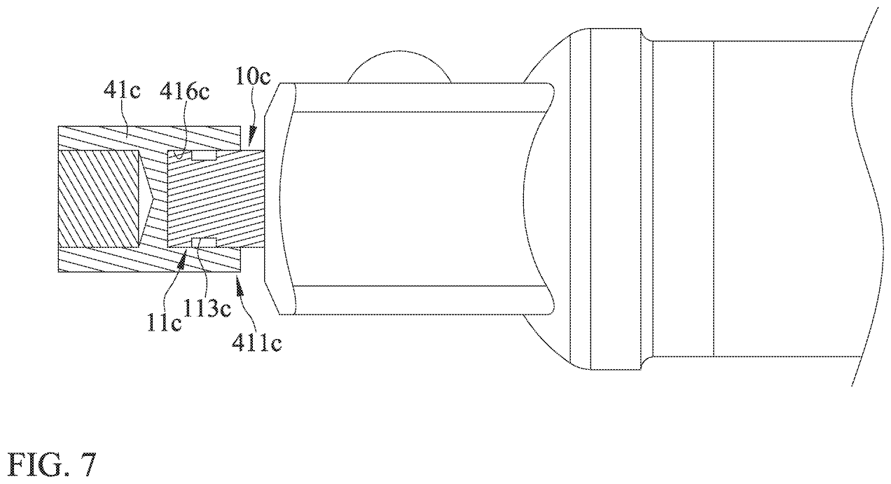

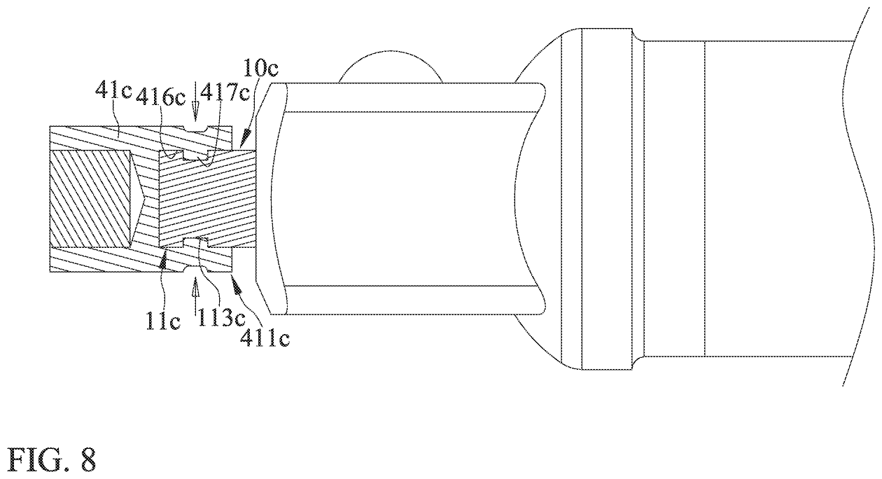

FIGS. 7 and 8 show a socket adaptor of a fourth embodiment according to the present invention. The fourth embedment is substantially the same as the first embodiment. The main differences are that the shank 10c is made of a first material, and wherein the limiting member 41c is made of a second material softer than the first material. For example, the shank 10c can be made of iron, and the limiting member 41c can be made of copper. Furthermore, the shank 10c further has an annular groove 113c formed on an outer periphery of the connecting end 11c. The limiting member 41c forms a mounting hole 416c at the proximal end 411c. The mounting hole 416c sleeves on the connecting end 11c of the shank 10c. As shown in FIG. 8, the limiting member 41c is configured that an outer surface of the proximal end 411c is punched and deformed by a radial force as arrowed in FIG. 8 to form an engaging portion 417c protruded from an inner surface of the mounting hole 416c and fixedly engaged with the annular groove 113c so that the proximal end 411c of the limiting member 41c is fixed to the connecting end 11c of the shank 10c.

Therefore, the magnetic device 40 extends into the socket 50 and magnetically attracts the fastener 60 to prevent the fastener 60 accidentally detached from the socket 50 or excessively shaking during operation. Thus, the socket adaptor can suitable with various different size sockets 50 and magnetically attract the fastener 60 without any magnet provided in the socket 50, thereby reducing the cost of the socket 50.

Although specific embodiments have been illustrated and described, numerous modifications and variations are still possible without departing from the scope of the invention. The scope of the invention is limited by the accompanying claims.

1. A socket adaptor comprising:
a shank having a connecting end and a driven end adapted to couple with a driving tool;
a body movably mounted on the shank;
a detent movably arranged between the shank and the body and configured to selectively engage with a socket as the body is moved relative to the shank; and
a magnetic device including a limiting member and a magnetic member, wherein the limiting member has a proximal end fixed to the connecting end of the shank, a distal end opposite to the proximal end, and a containing hole formed at the distal end, and wherein the magnetic member is arranged in the containing hole.

2. The socket adaptor as claimed in claim 1, wherein the proximal end of the limiting member is fixed to the connecting end of the shank in a tight fit manner.

3. The socket adaptor as claimed in claim 2, wherein the containing hole extends from the distal end to the proximal end and penetrates the proximal end, wherein an outer diameter of the connecting end is not less than an inner diameter of the containing hole, and wherein the containing hole is fixedly sleeved on the connecting end of the shank.

4. The socket adaptor as claimed in claim 3, wherein the containing hole extends radially inward to form a limiting portion adjacent to the distal end, wherein an inner diameter of the limiting portion is less than the inner diameter of the containing hole, and wherein the magnetic member is limited between an end face of the connecting end of the shank and the limiting portion.

5. The socket adaptor as claimed in claim 4, wherein two opposite sides of the magnetic member are respectively abutted against the end face of the connecting end of the shank and the limiting portion.

6. The socket adaptor as claimed in claim 4, wherein the magnetic member is movably arranged in the containing hole.

7. The socket adaptor as claimed in claim 2, wherein the shank forms an insertion hole at the connecting end, wherein the limiting member is provided with an insertion portion at the proximal end, wherein an outer diameter of the insertion portion is not less than an inner diameter of the insertion hole, and wherein the insertion portion is fixedly inserted and embedded in the insertion hole.

8. The socket adaptor as claimed in claim 1, wherein the shank is made of a first material, and wherein the limiting member is made of a second material softer than the first material.

9. The socket adaptor as claimed in claim 8, wherein the shank further has an annular groove formed on an outer periphery of the connecting end, wherein the limiting member forms a mounting hole at the proximal end, wherein the mounting hole sleeves on the connecting end of the shank, and wherein the limiting member is configured that an outer surface of the proximal end is punched and deformed by a radial force to form an engaging portion protruded from an inner surface of the mounting hole and fixedly engaged with the annular groove.

10. The socket adaptor as claimed in claim 1, wherein the limiting member is tubular, and wherein the magnetic member is cylindrical.
